(19) United States
(12) Patent Application Publication
(10) Pub. No.: US 2026/0175855 A1
(43) Pub. Date: Jun. 25, 2026

(54) Method for Operating a Driver Assistance System of a Vehicle With Automated Transverse Guidance in Following Mode, Driver Assistance System, and Vehicle

(71) Applicant: Bayerische Motoren Werke Aktiengesellschaft, Muenchen (DE)

(72) Inventor: Alexander GOETZ, Muenchen (DE)

(21) Appl. No.: 19/124,335

(22) PCT Filed: Oct. 23, 2023
(86) PCT No.: PCT/EP2023/079498

§ 371 Date: Apr. 25, 2025

(30) Foreign Application Priority Data
Oct. 26, 2022 (DE) 10 2022 128 390.9

(51) Int. Cl. B60W 50/14; B60W 30/12; B60W 30/18; B62D 15/02

(52) U.S. Cl. CPC B60W 50/14; B60W 30/12; B60W 30/18154; B60W 30/18163; B62D 15/025; B60W 2554/802

(57) ABSTRACT

A method for operating a driver assistance system of a vehicle includes checking whether lane markings are present in an environment of the vehicle, detecting other road users in the environment and determining a position and/or a movement of the respective other road users, activating a following mode in which a road user ahead is followed at least periodically with automated transverse guidance, if no lane markings are present in the environment, determining an imaginary ego lane in which the vehicle is moving and at least one imaginary adjacent lane adjoining the imaginary ego lane based on the position and/or the movement of the other road users, and deactivating the following mode if a lateral distance between the road user ahead and the at least one imaginary adjacent lane drops below a predetermined minimum distance.

### BACKGROUND AND SUMMARY

The present invention relates to a method for operating a driver assistance system of a vehicle. In addition, the present invention relates to a driver assistance system for a vehicle. Finally, the present invention relates to a vehicle with such a driver assistance system.

The interest in the present case is focused on driver assistance systems which support a driver in a transverse guidance of the vehicle. Such driver assistance systems, which are also referred to as steering and lane keeping assistants or also as active lane holding assistants, are used to keep the vehicle within a traffic lane. Such a driver assistance system uses the data from one or more environmental sensors of the vehicle to detect the boundaries of a traffic lane or the lane markings. If the lane markings are detected with a sufficient degree of certainty, the driver assistance system can be activated and steering interventions can be carried out in order to keep the vehicle within the traffic lane. For example, the steering interventions can occur in such a way that the vehicle is kept centered within the traffic lane.

In addition, lane holding assistants are known from the prior art in which, to a limited extent driving behind a front vehicle or a road user ahead is facilitated. In the case of such a following mode or object following mode, a monitoring of the lateral space next to the ego vehicle is necessary to prevent a collision with secondary objects during steering movements. This usually occurs using radar sensors mounted laterally on the vehicle, which can detect objects next to the vehicle. In the event of approaching a secondary object too closely with impending collision, a warning and/or a steering intervention can be output.

It is necessary to reduce the increased danger of collisions with secondary objects or adjacent objects during the active object following mode of an active lane holding assistant. In countries with very dense and unregulated traffic, for example, China, it often happens that a lane holding assistant switches to following mode due to lacking or poorly visible lane markings. If the road user ahead then changes lanes, while another object is still next to the ego vehicle, this could lead to a collision if the ego vehicle continues to follow the road user ahead. The previously described measure of monitoring the lateral space with radar sensors attempts to remedy this situation. However, due to technical limitations in the quality and precision of the object detection of the radar sensors, there is often either no reaction or late reactions and the threatening collision can no longer be averted.

The present invention addresses the problem of showing a solution for further improving the function of a driver assistance system to support the transverse guidance of the vehicle.

This problem is solved according to the invention by a method, by a driver assistance system and by a vehicle with the features according to the independent claims. Advantageous further developments of the present invention are specified in the dependent claims.

A method according to the invention is used to operate a driver assistance system of a vehicle. The method comprises checking whether lane markings are present in an environment of the vehicle. In addition, the method comprises recording further road users in the environment and determining a position and/or a movement of the respective further road users. The method also comprises activating a following mode, in which a road user ahead is at least periodically followed with automated transverse guidance, in case no lane markings are present in the environment. In addition, the method comprises the determination of an imaginary ego lane, in which the vehicle moves, and at least one imaginary adjacent lane, which adjoins the imaginary ego lane, based on the position and/or the movement of the further road users. The method also comprises the deactivation of the following mode, in case a lateral distance of the road user ahead to the at least one imaginary adjacent lane falls below a predetermined minimum distance.

In the method, environmental data can be provided by an environmental sensor. These environmental data can describe the surroundings of the vehicle or an environment of the vehicle. The environmental sensor can, for example, be a camera, by means of which image data may be provided as the environmental data. By means of the driver assistance system or a computing device of the driver assistance system, the lane markings which delimit respective lanes can then be detected in the environmental data.

If these lane markings are detected with a predetermined probability or certainty for a predetermined time period, an automated transverse guidance of the vehicle can be activated on the basis of the lane markings. This means, in particular, that by means of the driver assistance system a steering torque is provided or a steering intervention steering intervention is carried out, in order to keep the vehicle within the lane or within the detected lane markings.

Using the environmental data, it is also possible to check whether further road users are present in the environment or the surroundings of the vehicle. The system checks whether among the detected road users such a road user is present who is in the forward direction in front of the vehicle and driving in front of the ego vehicle. This road user will subsequently be referred to as a road user ahead. It is not absolutely necessary that the road user ahead is a road user immediately in front of the vehicle.

If no lane markings are currently detected in the environment of the vehicle and at the same time such a road user ahead was detected, said road user ahead may be followed in following mode. In the event of following, for example, the relative location of the road user ahead to the ego vehicle may be continuously determined based on the environmental data of the environmental sensors and the transverse guidance of the vehicle may be adapted such that the road user ahead is followed with respect to the transverse guidance. Provision is also made that a longitudinal guidance of the vehicle is adapted to the road user ahead by means of the driver assistance system. For example, this can be achieved by means of an adaptive speed regulation or by means of an intelligent cruise control.

According to the present invention, provision is made that based on the environmental data the position and/or the movement of the respective road users in the environment of the vehicle are determined. Imaginary lanes are determined based on the respective positions and/or movements of the further road user. For one thing, an imaginary ego lane is determined as an imaginary lane, which describes the lane in which the ego vehicle is also located. In addition, at least one imaginary adjacent lane is determined as an imaginary lane, which is allocated to the road users who are located laterally next to the ego vehicle or on the adjacent lanes.

For example, first an evaluation of the collective imaginary lane of all vehicles around the ego vehicle can take place. In principle, any number of imaginary lanes can be defined, of which it is assumed that all road users are moving within these imaginary lanes. For example, the imaginary lane can be determined based on the arrangement of the other road users. If, for example, the other road users are driving in single file, an imaginary lane can be assigned to them. For example, if the other road users lie within a tolerance range with respect to the lateral offset to one another, a common imaginary lane can be assigned to them. These imaginary lanes can be technically defined by their respective lane center. Alternatively, or in addition, the imaginary lane can be defined by imaginary lane markings.

During the activated following mode, the lateral distance of the road user ahead, who is being followed, to the at least one imaginary adjacent lane can now be determined. The lateral distance can extend along the vehicle transverse direction of the other road user or perpendicular to the main direction of extension of the imaginary adjacent lane. In case this lateral distance falls below a predetermined minimum distance, the following mode can be deactivated. The minimum distance can be determined dependent on the situation. For example, the minimum distance can be determined proportionally to a standard lane width or to a previously determined lane width. In addition, the minimum distance can be determined depending on the current speed, the traffic density or the like.

To detect whether the road user ahead, which the ego vehicle is following in following mode of the active lane holding assistant, is changing to a different lane, the lateral distance to the at least one imaginary adjacent lane can be determined. In case several imaginary adjacent lanes are determined, the lateral distance to the respective determined imaginary adjacent lane can be determined. If it is now detected that the lateral distance falls below the minimum distance, it can be assumed that the vehicle in front or the road user ahead would like to make a lane change to the adjacent lane or is already making said lane change.

Based on the determination of the imaginary lane or of the imaginary ego lane and the at least one imaginary adjacent lane, a lane change of the road user ahead can also be detected in following mode, in which no real lane markings are detected. As a result of the fact that, in the event of a detected lane change of the road user ahead, the object following mode or the following mode is cancelled, a collision of the ego vehicle with other road users, who are located next to the ego vehicle, can be reliably prevented. Hence, overall, the safety of the driver assistance system can be improved. In addition, due to the method of the invention there is also the advantage that a random selection of environmental sensors can be used to prevent collisions with adjacent objects and lateral radars do not necessarily have to be used.

Preferably, prior to deactivating following mode an output to a driver of the vehicle is output and the automated transverse guidance of the vehicle is subsequently terminated. For example, if the system detects that the lateral distance of the vehicle in front or of the road user ahead to the at least one imaginary adjacent lane falls below the minimum distance, a warning or an output can be output to the driver of the vehicle. This output can notify the driver that following mode or the automated transverse guidance is being deactivated. In other words, following mode can be terminated together with the output of the warning. This also means that the automated transverse guidance of the vehicle is terminated, in order to prevent a collision with road users located laterally next to the vehicle. After the output of the warning, the driver can resume control over the steering and keep the vehicle in its current lane. Hence, safety can be guaranteed in the event of a lane change of the road user ahead.

In another embodiment, another road user is detected in the imaginary ego lane in front of the road user ahead and after deactivating following mode, this detected other road user is followed at least periodically with automated transverse guidance. For example, if during active following mode the system detects that the vehicle in front or the road user ahead is planning a lane change or is starting a lane change maneuver, it is possible to check whether another road user is in the imaginary ego lane in the forward direction in front of this road user ahead. In other words, following mode can switch to the next front vehicle or the other road user in front of the road user ahead. For example, this can happen automatically, in case the other road user in front of the road user ahead is reliably detected. In the process, following mode on the road user ahead can be first deactivated and subsequently following mode may be resumed with respect to the object in front, which at a later time then is the road user ahead. Provision may also be made that an output or a notification is output to the driver that following mode is being continued based on a new front vehicle or that a following mode is being carried out with a new road user ahead. On the whole, the comfort for the driver when the lane holding assistant is active can be improved.

In addition, it is advantageous if the position and/or the movement of the other road users is continuously recorded and the deactivation of following mode is additional determined depending on the recorded position and/or movement of the other road users. For example, the driver assistance system can continuously detect and store the positional and movement data of the surrounding road users or vehicles during active following mode. Based on these positional and movement data of the other road users it is possible to continuously check whether a collision between the vehicle and one of the other road users is imminent. This can, for example, be detected using a flowing or continuous movement of another road user who is moving in the direction of the vehicle of the imaginary ego lane. In this case, a notice can then be output to the driver and/or following mode can be deactivated. In addition, provision can be made that corresponding driving interventions are carried out by means of the driver assistance system, to prevent potential collisions with other road users.

In this connection, provision is made that following mode is deactivated, in case a narrowing of the road is detected using the recorded position and/or movement of the other road users, in which other road users move from the imaginary adjacent lane to the imaginary ego lane. In particular, following mode should be deactivated in case other road users change from an imaginary adjacent lane to the imaginary ego lane. Preferably, following mode should be deactivated, in case another road user changes or would like to change from the imaginary adjacent lane to a space between the ego vehicle and the road user ahead. Such a situation arises, for example, in the event of a narrowing of the road in which the road users who are currently on the imaginary adjacent lane are led to the imaginary ego lane. When such road narrowings are reliably detected, collisions with other road users can be prevented.

In another embodiment, the imaginary ego lane and/or the at least one imaginary adjacent lane are only determined in case a predetermined minimum number of other road users is recorded. To guarantee a reliable determination of the imaginary road users, a predetermined minimum number of road users, on the basis of which the imaginary lane is determined, can be taken as a basis. For example, provision can be made that an imaginary lane will only be determined or defined in case at least two road users, preferably at least three road users, can be assigned to this imaginary lane. In particular, the imaginary lane, that is, the imaginary ego lane and the at least one imaginary adjacent lane, can be determined in congested traffic situations. In these congested traffic situations the imaginary lane or the collective lanes can be reliably determined. This reduces the susceptibility for false positive deactivations of the system and simultaneously makes a high sensitivity available in the event of dense traffic.

In another embodiment, the imaginary ego lane and/or the at least one imaginary adjacent lane are determined while the vehicle is driving over an intersection. No lane markings may be present in the area of intersections. The case may also arise that the lane markings cannot be reliably detected on intersections. In particular, the method can be advantageously employed at intersections with several lanes. Hence, the driver can be reliably supported in maneuvering the vehicle when crossing the intersection.

A driver assistance system for the vehicle according to the invention is equipped to check whether lane markings are present in an environment of the vehicle. In addition, the driver assistance system is equipped to activate a following mode in which a road user ahead is at least periodically followed with automated transverse guidance. This applies for the case that no lane markings are present in the environment. In addition, the driver assistance system is equipped to determine an imaginary ego lane, in which the vehicle is moving, and at least one imaginary adjacent lane, which adjoins the imaginary ego lane, based on the position and/or movement of the other road users. Moreover, the driver assistance system is equipped to deactivate the following mode when a lateral distance of the road user ahead to the at least one imaginary adjacent lane falls below a predetermined minimum distance.

The driver assistance system can have at least one environmental sensor, by means of which environmental data may be provided. The other road users can be detected by means of a computing device of the driver assistance system. In addition, the driver assistance system can have an output device, to output an output to the driver of the vehicle. Further, the driver assistance system can assume the transverse guidance and preferably also the longitudinal guidance of the vehicle, to follow the road user ahead.

A vehicle according to the invention comprises a driver assistance system according to the invention. The vehicle is configured, for example, as a passenger car.

The preferred embodiment presented with respect to the method according to the invention and its advantages apply correspondingly for the driver assistance system according to the invention and the vehicle according to the invention.

Further features of the invention arise from the claims, the figures and the description of the figures. The features and feature combinations mentioned above in the description as well as the features and feature combinations mentioned subsequently in the description of the figures and/or the features and feature combinations shown solely in the figures may be used not only in the respective specified combination, but also in other combinations or alone, without departing from the scope of the invention.

The invention will now be described in greater detail based on preferred exemplary embodiments as well as with reference to the attached drawings. The figures show the following:

### BRIEF DESCRIPTION OF THE DRAWINGS

FIG. 1 shows a schematic representation of a vehicle which has a vehicle assistance system;

FIG. 2 shows the vehicle according to FIG. 1 in a traffic situation, in which a plurality of other road users is in the environment of the vehicle and no lane markings are present;

FIG. 3 shows the traffic situation from FIG. 2 at a later time, wherein imaginary lanes have been determined and the vehicle follows a road user ahead in a following mode;

FIG. 4 shows the traffic situation according to FIG. 3 at a later time, wherein the road user ahead is performing a lane change; and

FIG. 5 shows the traffic situation according to FIG. 4, wherein a lateral distance of the road user ahead to an imaginary lane is determined.

### DETAILED DESCRIPTION OF THE DRAWINGS

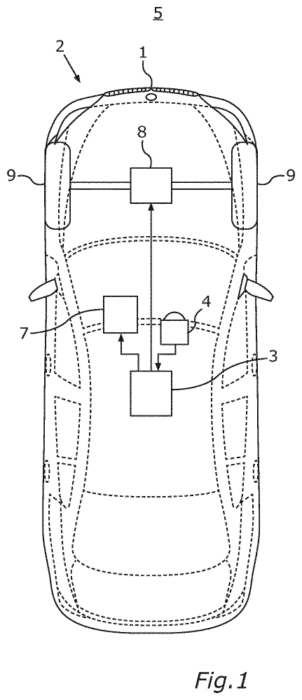

FIG. 1 shows a vehicle 1, which is embodied here as a passenger car, in a top view. The vehicle 1 comprises a driver assistance system 2, by means of which a driver of the vehicle 1 can be supported in the transverse guidance of the vehicle 1. The driver assistance system comprises a computing device 3, which can be formed by at least one electronic controller of the vehicle 1.

In addition, the driver assistance system 2 comprises at least one environmental sensor 4. In the presented example, the driver assistance system 2 comprises an environmental sensor 4, which is presently embodied as a camera. The environmental sensor 4 can be used to provide environmental data or image data, which describe an environment 5 of the vehicle 1.

The computing device 3 is further equipped to control a steering system 8 of the vehicle 1 shown only schematically here. By controlling the steering system 8, a steering torque or a steering intervention can be generated. By controlling the steering system 8, the steerable wheels 9 of the vehicle 1 may be steered and hence the direction of the vehicle 1 may be influenced. In addition, the driver assistance system 2 can assume a longitudinal guidance of the vehicle 1.

The driver assistance system 2 also comprises an output device 7, by means of which an output may be output to the driver or user of the vehicle 1. The output device 7 can comprise at least one display device or a display, with which an optical display can be provided as output. In addition, the output device 7 can provide an acoustical and/or a haptic output.

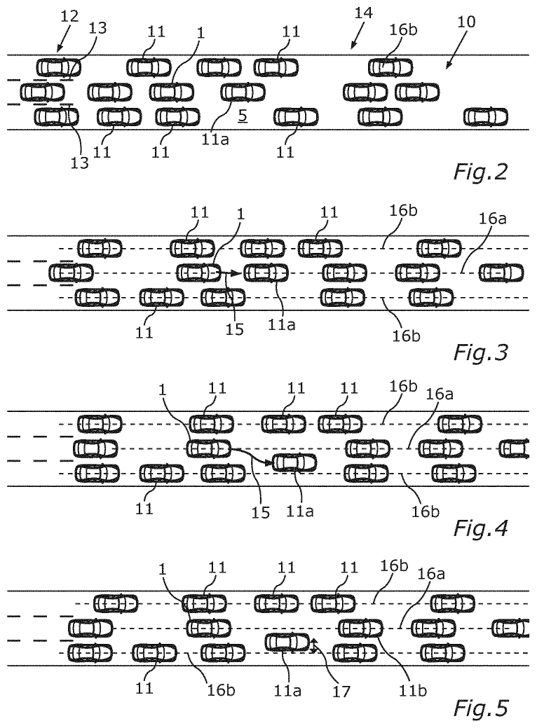

FIG. 2 shows the vehicle 1 according to FIG. 1 in a traffic situation. In this connection, the vehicle 1 is located on a street 10. A plurality of other road users 11 are located on the street 10 or in the environment 5 of the vehicle 1. The vehicle 1 is maneuvered with automated guidance on the street 10 by means of the driver assistance system 2. A region 12 is assigned to the street 10, in which lane markings 13 are present. Currently the vehicle is in a region 14 in which no lane markings 13 can be recorded. The region 14 can be assigned to an intersection.

There is heavy traffic on the road and a plurality of other road users 11 are present in the environment 5 of the vehicle 1. Based on the environmental data of the environmental sensor 4, the position and/or the movement of the other road users 11 may be continuously recorded. In particular, the movement of the road user ahead 11a is determined, which is in a forward direction in front of the ego vehicle 1. This road user ahead 11a is followed with automated transverse guidance during a following mode and also with automated longitudinal guidance.

FIG. 3 shows the traffic situation from FIG. 2 at a later time. In this connection, the road user ahead 11a is being followed. This is illustrated by the planned trajectory 15, along which the driver assistance system 2 or the lane holding assistant of the vehicle 1 is maneuvering. Hence, the road user ahead 11a can also be followed without lane markings 13. Based on the recorded position and/or movement of the other road users 11 imaginary lanes 16a, 16b are also determined. Here an imaginary ego lane 16a is determined, upon which the ego vehicle 1 is also moving. In addition, to the right and the left next to the imaginary ego lane 16a, in each case an imaginary adjacent lane 16b is determined. These imaginary lanes 16a, 16b are detected because the other road users are driving in single file along the respective imaginary lane 16a, 16b. Presently, the respective lane centers of the imaginary lane 16a, 16 are shown.

FIG. 4 shows the traffic situation from FIG. 3 at a later time. In this connection, it can be recognized that the road user ahead 11a would like to perform a lane change maneuver from the lane, upon which the ego vehicle 1 is located, to the lane to the right, arranged next to this lane. Presently, a space has opened up on this lane, to which the road user ahead 11a would like to switch.

Possible lane changes of the road user ahead 11a should be reliably detected during following mode. To this end, FIG. 5 shows the traffic situation from FIG. 4, in which a lateral distance 17 to the imaginary adjacent lane 16b is continuously determined during the following mode. In case this lateral distance 17 falls below a predetermined minimum distance, the following mode can be terminated. This prevents the ego vehicle 1 from following the road user ahead 11a and hence, prevents a collision from occurring with another road user 11a, who is laterally next to the vehicle 1.

In case the lateral distance 17 falls below the predetermined minimum distance, which for example, could be one meter or less, the automated lateral guidance or the following mode can be deactivated. In this case, a corresponding warning can be output to the driver of the vehicle 1. Consequently, the vehicle can be subsequently manually guided by the driver. Provision can also be made that another road user 11b is determined, who is located in a forward direction in front of the road user ahead 11a. After the lane change of the road user ahead 11a, the other road user 11b or the next front object can be followed.

1-9. (canceled)

10. A method for operating a driver assistance system of a vehicle, the method comprising:
checking whether lane markings are present in an environment of the vehicle;
recording other road users in the environment and determining a position and/or a movement of the other road users;
activating a following mode, in which a road user ahead of the vehicle is followed at least periodically with automated transverse guidance, in case no lane markings are present in the environment;
determining an imaginary ego lane, in which the vehicle is moving, and at least one imaginary adjacent lane, which adjoins the imaginary ego lane, based on the position and/or the movement of the other road users; and
deactivating the following mode in case a lateral distance of the road user ahead to the at least one imaginary adjacent lane falls below a predetermined minimum distance.

11. The method according to claim 10, wherein, prior to the deactivating of the following mode an output to a driver of the vehicle is output and the automated transverse guidance of the vehicle is subsequently terminated.

12. The method according to claim 10, wherein another road user in the imaginary ego lane is recorded in front of the road user ahead and after the deactivation of the following mode the road user ahead follows the another road user at least periodically with automated transverse guidance.

13. The method according to claim 11, wherein another road user in the imaginary ego lane is recorded in front of the road user ahead and after the deactivation of the following mode the road user ahead follows the another road user at least periodically with automated transverse guidance.

14. The method according to claim 10, wherein the position and/or the movement of the other road users is continuously recorded and the deactivation of the following mode is determined depending on the position and/or the movement of the other road users.

15. The method according to claim 14, wherein the following mode is deactivated in case a narrowing of the road is detected using the position and/or the movement of the other road users, in which the other road users move from the at least one imaginary adjacent lane to the imaginary ego lane.

16. The method according to claim 10, wherein the imaginary ego lane and/or the at least one imaginary adjacent lane are only determined in case a predetermined minimum number of the other road users is recorded.

17. The method according to claim 11, wherein the imaginary ego lane and/or the at least one imaginary adjacent lane are only determined in case a predetermined minimum number of the other road users is recorded.

18. The method according to claim 12, wherein the imaginary ego lane and/or the at least one imaginary adjacent lane are only determined in case a predetermined minimum number of the other road users is recorded.

19. The method according to claim 14, wherein the imaginary ego lane and/or the at least one imaginary adjacent lane are only determined in case a predetermined minimum number of the other road users is recorded.

20. The method according to claim 10, wherein the imaginary ego lane and/or the at least one imaginary adjacent lane are determined while the vehicle is driving over an intersection.

21. The method according to claim 11, wherein the imaginary ego lane and/or the at least one imaginary adjacent lane are determined while the vehicle is driving over an intersection.

22. The method according to claim 12, wherein the imaginary ego lane and/or the at least one imaginary adjacent lane are determined while the vehicle is driving over an intersection.

23. The method according to claim 14, wherein the imaginary ego lane and/or the at least one imaginary adjacent lane are determined while the vehicle is driving over an intersection.

24. A driver assistance system for a vehicle, the driver assistance system being configured to:
check whether lane markings are present in an environment of the vehicle;
record other road users in the environment and to determine a position and/or a movement of the other road users;
activate a following mode, in which a road user ahead of the vehicle is followed at least periodically with automated transverse guidance, in case no lane markings are present in the environment;
determine an imaginary ego lane, in which the vehicle is moving, and at least one imaginary adjacent lane, which adjoins the imaginary ego lane, based on the position and/or the movement of the other road users; and
deactivate the following mode in case a lateral distance of the road user ahead to the at least one imaginary adjacent lane falls below a predetermined minimum distance.

25. A passenger car comprising a driver assistance system according to claim 24.
